(19) United States
(12) Patent Application Publication
(10) Pub. No.: US 2006/0172082 A1
(43) Pub. Date: Aug. 3, 2006

(54) METHOD FOR MANUFACTURING FUNCTIONAL SUBSTRATE FUNCTIONAL SUBSTRATE METHOD FOR FORMING FINE PATTER CONDUCTIVE FILM WIRING ELECTRO-OPTICAL DEVICE AND ELECTRONIC APPARATUS

(75) Inventor: Takashi Masuda, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/297,333

(22) Filed: Dec. 9, 2005

(30) Foreign Application Priority Data
Feb. 1, 2005 (JP) 2005-025129

(51) Int. Cl. B05D 3/00; B05D 5/12

(52) U.S. Cl. 427/532; 427/58

(57) ABSTRACT

A method for manufacturing a functional substrate includes performing a first treatment on a substrate body, and forming a self-assembled film on the substrate body on which the first treatment has been performed, a treatment condition of the first treatment and a forming condition of the self-asembled film being set so as to satisfy a relation of A/B≦0.60, wherein A (°) is a receding contact angle of the self-assembled film with respect to a given droplet, and B (°) is an advancing contact angle of the self-assembled film with respect to the droplet.

### BACKGROUND

1. Technical Field

The present invention relates to a method of manufacturing a functional substrate, a method of manufacturing a wiring substrate, a method of manufacturing a electro-optical device, and a method of manufacturing a electronic apparatus.

2. Related Art

Researches on so-called a liquid process, in which functional materials are dissolved or dispersed in a liquid so as to be a functional liquid and the functional liquid is coated on substrates and dried so as to attain a functional film, are recently actively carried out from reasons that the process shows low costs and low environmental loads. As one of the liquid processes, an inkjet method is brought to an attention from viewpoints that it reduces material usage and is adaptable for a large size substrate. An organic electroluminescence (EL), organic thin film transistor (TFT), and a direct drawing of metal wirings are exemplified as a typical research. Since the liquid process uses a liquid for a starting material as its name suggests, the surface condition of the substrate serving as an underlayer on which the liquid is coated, particularly its wettability, is important.

Sufficient wettability enhances the wide spreading of droplets, decreasing resolving power of a patterning. As a result, a fine wiring and thicker film are difficult to be achieved. In contrast, poor wettability causes few droplets wet, resulting in not only no film being formed but also a liquid pool (bulge) being made by combining droplets landed on a substrate and pre-existing droplets on the substrate. As a result, the problem of a wire breakage, a short, or the like arises.

Here, the relationship between the bulge and the wire breakage, and between the bulge and the short will be described. FIG. 8 shows an occurrence of the bulge and wire breakage in a conductive film wiring. As shown in FIG. 8, each of bulges (liquid pools) B1, B2, and B3 occur on respective conductive film wirings A1, A3, and A4. The occurrence of such bulge easily causes the short in a case where the pitch between adjacent conductive film wirings is relatively small. In the case shown in FIG. 8, the conductive film wirings A1 and A2 are shorted at the shorted part X1 as a result of bringing the bulge B1 that occurs on the conductive film wiring A1 into a contact with the adjacent conductive film wiring A2. In addition, the bulge such as described above occurs generally as a result of drawing surrounding liquid, resulting in the amount of the surrounding liquid being relatively lessened. Therefore, the width of the conductive film wiring shows a tendency to increase its variation. Such increased variation sometimes causes the occurrence of unexpected and unwanted wire breakage on the conductive film wiring. In FIG. 8, the wire breakage occurs at the broken part X2 on the conductive film wiring A1. As described above, the occurrence of bulge leads to a fatal flaw in the performance of conductive film wirings.

In order to prevent the above-described problem from the occurrence, a method is proposed in JP-A-2003-133691. In the method, discharging is carried out more than two steps in the method for forming a film pattern by an inkjet method, and the discharged position, discharged pitch, and diameter of the droplet are defined so as to prevent the bulge or wire breakage from the occurrence. The method, however, needs to carry out the second and subsequent steps of discharging a droplet after thoroughly drying out discharged droplets, resulting in remarkably long time being taken for forming a thin film. This is not in practical steps.

### SUMMARY

An advantage of the invention is to provide a functional substrate that can ensure to form a thin film having a fine pattern by a liquid process, a method for manufacturing the functional substrate, a method for forming a fine pattern that can ensure to form a thin film having a desired pattern, a conductive film wiring having a fine pattern without any wire breakages, shorts, etc., an electro-optical device and an electronic apparatus that have the conductive film wiring.

The advantage of the invention will be further described below.

A method for manufacturing a functional substrate according to a first aspect of the invention includes a first process for performing a first treatment on a substrate body (base board), a second process for forming a self-assembled film on the substrate body on which the first treatment has been performed, a treatment condition of the first treatment and a forming condition of the self-assembled film are set so as to satisfy a relation of A/B≦0.60, where A (°) is a receding contact angle of the self-assembled film with respect to a given droplet, and B (°) is an advancing contact angle of the self-assembled film with respect to the droplet.

As a result, the method for manufacturing a functional substrate can be provided that can preferably be used to form a thin film having a fine pattern by a liquid process.

The method for manufacturing a functional substrate of the first aspect of the invention preferably sets the treatment condition of the first treatment and the forming condition of the self-assembled film so as to satisfy a relation of A/C≦0.70, where A (°) is the receding contact angle of the self-assembled film with respect to the given droplet, and C (°) is a static contact angle of the self-assembled film with respect to the droplet.

As a result, the method can preferably be used to form a thin film having a fine pattern.

The method for manufacturing a functional substrate of the first aspect of the invention preferably sets the treatment condition of the first treatment and the forming condition of the self-assembled film so as to satisfy a relation of C−[(A+B)/2]≧5.0, where A (°) is the receding contact angle of the self-assembled film with respect to the given droplet, B (°) is the advancing contact angle of the self-assembled film with respect to the droplet, and C (°) is the static contact angle of the self-assembled film with respect to the droplet.

As a result, the method can preferably be used to form a thin film having a fine pattern.

In the method for manufacturing a functional substrate of the first aspect of the invention, the first treatment is preferably an oxygen plasma treatment.

This allows the receding contact angle of the self-assembled film with respect to the droplet to be effectively lessened while the advancing contact angle of the self-assembled film with respect to the droplet is sufficiently large. As a result, A/B or the like can surely be a preferable value.

In the method for manufacturing a functional substrate of the first aspect of the invention, a radio frequency (RF) intensity in the oxygen plasma treatment is preferably from 0.005 to 0.2 W/cm².

This allows the receding contact angle of the self-assembled film with respect to the droplet to be effectively lessened while the advancing contact angle of the self-assembled film with respect to the droplet is sufficiently large. As a result, A/B or the like can surely be a preferable value.

In the method for manufacturing a functional substrate of the first aspect of the invention, a flow rate of process gas in the oxygen plasma treatment is preferably from 10 to 500 standard cubic centimeters per minute (sccm).

This allows the receding contact angle of the self-assembled film with respect to the droplet to be effectively lessened while the advancing contact angle of the self-assembled film with respect to the droplet is sufficiently large. As a result, A/B or the like can surely be a preferable value.

In the method for manufacturing a functional substrate of the first aspect of the invention, a temperature of an atmosphere in the oxygen plasma treatment is preferably from 0 to 100 degrees centigrade.

This allows the receding contact angle of the self-assembled film with respect to the droplet to be effectively lessened while the advancing contact angle of the self-assembled film with respect to the droplet is sufficiently large. As a result, A/B or the like can surely be a preferable value.

In the method for manufacturing a functional substrate of the first aspect of the invention, processing time of the oxygen plasma treatment is preferably from 1 to 600 seconds.

This allows the receding contact angle of the self-assembled film with respect to the droplet to be effectively lessened while the advancing contact angle of the self-assembled film with respect to the droplet is sufficiently large. As a result, A/B or the like can surely be a preferable value.

In the method for manufacturing a functional substrate of the first aspect of the invention, the self-assembled film is preferably a material including a fluoro group.

This allows uniform lyophobicity to be given on a surface of the functional substrate (self-assembled film), enabling a thin film having a fine pattern to be surely formed.

In the method for manufacturing a functional substrate of the first aspect of the invention, the constituent molecule of the self-assembled film is preferably adsorbed on the substrate at a rate of from 0.01×10¹⁵ to 1×10¹⁵ pieces/cm², forming the self-assembled film.

This allows the receding contact angle of the self-assembled film with respect to the droplet to be effectively lessened while the advancing contact angle of the self-assembled film with respect to the droplet is sufficiently large. As a result, A/B or the like can surely be a preferable value.

A functional substrate of a second aspect of the invention is manufactured by the method of the first aspect of the invention.

As a result, the functional substrate can be provided that can preferably be used to form a thin film having a fine pattern by a liquid process.

A method for forming a fine pattern of a third aspect of the invention includes discharging a droplet in a given pattern so as to form a thin film having a fine pattern corresponding to the given pattern.

As a result, a method for manufacturing a fine pattern can be provided that is capable to surely form a thin film having a desired pattern.

In the method for forming a fine pattern of the third aspect of the invention, the droplet preferably contains a conductive fine particle.

As a result, for example, a conductive film wiring can be formed that has a thick film that is advantageous for electric conduction and hardly causes the defect such as wire breakage or short, and is further fine.

A conductive film wiring of a fourth aspect of the invention is formed by using the method for manufacturing a fine pattern of the third aspect of the invention.

As a result, a conductive film wiring can be provided that has a thick film that is advantageous for electric conduction, hardly causes the defect such as wire breakage or short, and is further fine.

An electro-optical device of a fifth aspect of the invention includes the conductive film wiring of the fourth aspect of the invention.

This allows an electro-optical device having high reliability to be provided, as well as the electro-optical device to be small and thin.

An electronic apparatus of a sixth aspect of the invention includes the conductive film wiring of the fourth aspect of the invention.

This allows an electronic apparatus having high reliability to be provided, as well as the electronic apparatus to be small and thin.

### BRIEF DESCRIPTION OF THE DRAWINGS

The invention will be described with reference to the accompanying drawings, wherein like numbers refer to like elements.

FIG. 1 is a schematic diagram illustrating a surface condition of a functional substrate according to the invention.

FIG. 2 is an explanatory view illustrating an advancing contact angle, a receding contact angle, and a static contact angle.

FIG. 3 is a schematic structural view of a treatment device for forming a self-assembled film.

FIG. 4 is a plan view illustrating a first substrate of a liquid crystal device according to the invention.

FIG. 5 is an exploded perspective view of a plasma display device according to the invention.

FIG. 6A is a schematic view illustrating an example of a cellular phone including a liquid display device shown in FIG. 4, FIG. 6B is a schematic view illustrating an example of a portable information processor including the liquid display device shown in FIG. 4, and FIG. 6C is an example of a wristwatch type electronic apparatus including the liquid display device shown in FIG. 4, all of which are electronic apparatus according to the invention.

FIG. 7 is an exploded perspective view illustrating a non-contact card medium according to the invention.

FIG. 8 is an explanatory view illustrating a relationship between a bulge and a wire breakage, and between the bulge and a short.

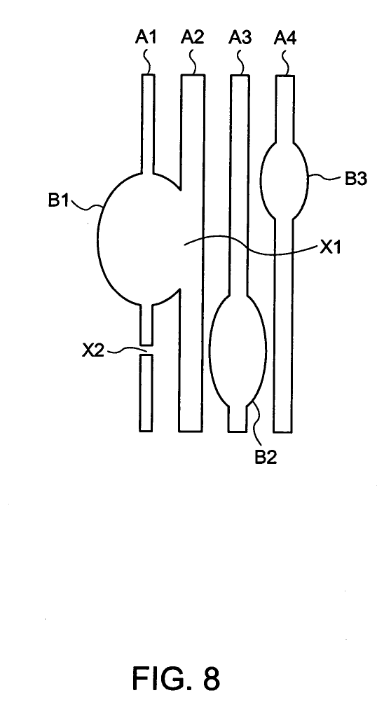

### DESCRIPTION OF THE EMBODIMENTS

Hereinafter, preferred embodiments of a method for manufacturing a functional substrate, a functional substrate, a method for forming a fine pattern, a conductive film wiring, an electro-optical device and an electronic apparatus according to the invention will be minutely described with reference to accompanying drawings.

First, a functional substrate and a method thereof according to the invention are described. While a functional substrate on which a conductive film wiring is formed as a fine pattern by a droplet method using a liquid containing a conductive fine particle will be exemplified as an example of the functional substrate in the following explanations, the invention may be applied to a functional substrate on which a fine pattern other than the conductive film wiring is formed, a functional substrate that is used except for forming the fine pattern, or the like.

Functional Substrate

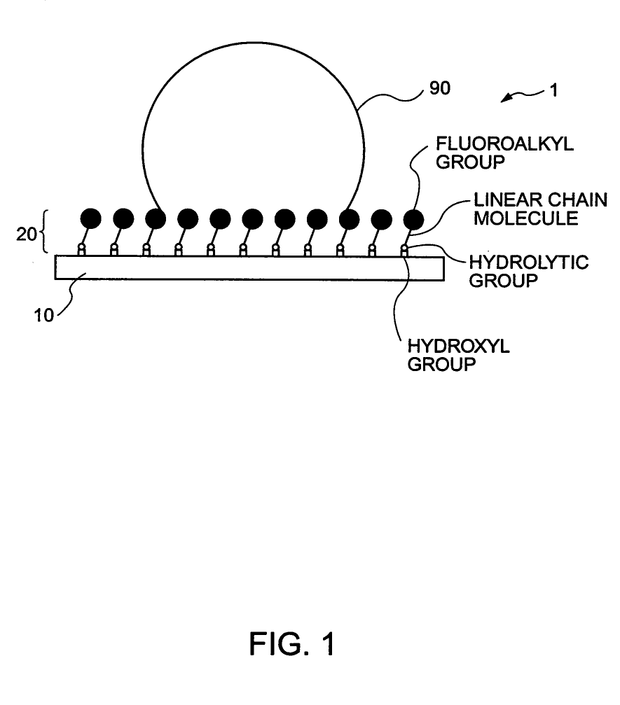

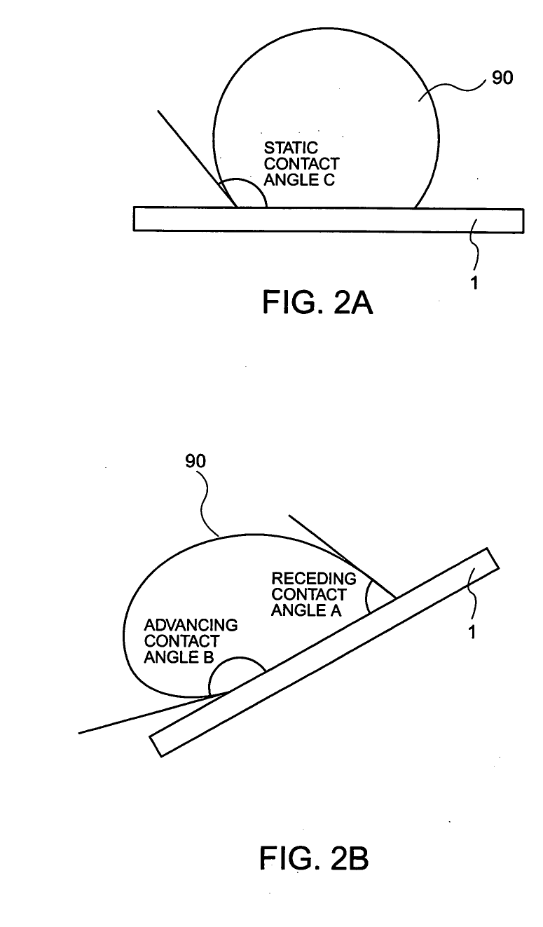

FIG. 1 is a schematic view illustrating an example of the functional substrate according to the invention. FIG. 2 is an explanatory view illustrating an advancing contact angle, a receding contact angle, and a static contact angle.

As shown in FIG. 1, a functional substrate 1 includes a substrate body (base board) 10 and a self-assembled film 20 formed on the surface of the substrate body 10.

The self-assembled film 20 is obtained by a chemical adsorption in which a functional group at one end of a molecule is selectively chemically adsorbed to an atom contained in a base member (substrate body). The self-assembled film 20 can adjust its physical chemical characteristics such as lyophilicity, lyophobicity, optical characteristics, electrical characteristics by selecting a type of the functional group (particularly, an end group at the opposite end of the functional group that is chemically adsorbed on the base member) of its constituent molecule.

Recently, researches on a liquid process using an element (functional substrate) having such self-assembled film are actively carried out. Since the self-assembled film can adjust various characteristics by selecting a type of the functional group (particularly, an end group at the opposite end of the functional group chemically adsorbed on the base) of its constituent molecule as described above, for example, forming a fine pattern having a small line width is attempted by forming a self-assembled film having high lyophobicity. However, in the self-assembled film having excess lyophobicity, liquid is prevented from being wetted and spread whereas droplets gather (coagulate) by influences of the liquid's own surface tension, resulting in the bulge (liquid pool) easily being formed. The formed bulge makes a desired fine pattern difficult to be formed if a thin line is to be formed.

The inventor was dedicated to conducting researches in order to provide a functional substrate that can preferably be used for forming a desired fine pattern by preventing liquid from being unnecessarily wetted and spread on a self-assembled film as well as preventing the liquid applied on the self-assembled film from being coagulated. As a result, it is found that advantages described above can be achieved by carrying out a treatment (a first process) on a substrate body and a forming of a self-assembled film (a second process) under conditions satisfying a relationship among contact angles as minutely described below.

Relationship Among Contact Angles

The functional substrate 1 satisfies a relation of A/B≦0.60, where A (°) is the receding contact angle of the self-assembled film 20 with respect to a droplet 90 given, and B (°) is the advancing contact angle of the self-assembled film 20 with respect to the droplet 90. The satisfied relationship allows the liquid applied on the self-assembled film 20 to be prevented from being unnecessarily wetted and spread as well as being coagulated. Accordingly, the drawback such as unexpected and unwanted wire breakage or bulge can surely be prevented from the occurrence in a case where the functional substrate 1 is applied to forming a thin film having a fine pattern by the liquid process. Namely, the functional substrate 1 can preferably be applied to forming the thin film having a fine pattern by the liquid process. As described above, the functional substrate 1 satisfies the relation of A/B≦0.60, but more preferably O≦A/B≦0.30, and still more preferably 0.15≦A/B≦0.30. Consequently, the effects described above are more markedly exhibited.

In the invention, as shown in FIG. 2A, the static contact angle is defined as the angle that the liquid surface makes with respect to the substrate surface at the place where the free surface of quiescent liquid contacts to the horizontal surface of the substrate. In addition, as shown in FIG. 2B, the advancing contact angle and receding contact angle are defined at the time when the droplet starts to slip and move downwardly as a result of gradually slanting the substrate from the condition in which the droplet placed on the substrate having a flat surface. The advancing contact angle is defined as the angle that the liquid surface makes with respect to the substrate surface at a slope front side (lower side of the slope) of the slanted substrate surface, while the receding contact angle is defined as the angle that the liquid surface makes with respect to the substrate surface at a slope back side (upper side of the slope) of the slanted substrate surface. Here, each of these is the contact angle at a room temperature (25 degrees of centigrade).

In addition, it is preferable that the relation of A/C≦0.70 is satisfied, more preferably the relation of 0<A/C≦0.50 is satisfied, still more preferably the relation of 0.25<A/C≦0.35 is satisfied, where A (°) is the receding contact angle of the self-assembled film 20 with respect to the droplet 90, and C (°) is the static contact angle of the self-assembled film 20 with respect to the droplet 90. By satisfying the relations, the effects described above are more markedly exhibited.

In addition, it is preferable that the relation of C−[(A+B)/2]≧5.0 is satisfied, more preferably the relation of 7.0≦C−[(A+B)/2]≦20.0 is satisfied, and still more preferably the relation of 7.0≦C−[(A+B)/2]≦15.0 is satisfied, where A (°) is the receding contact angle of the self-assembled film 20 with respect to the droplet 90, B (°) is the advancing contact angle of the self-assembled film 20 with respect to the droplet 90, and C (°) is the static contact angle of the self-assembled film 20 with respect to the droplet 90. By satisfying the relations, the effects described above are more markedly exhibited.

While any specific values of the receding contact angle A of the self-assembled film 20 with respect to the liquid 90 are particularly not limited to, from 0 to 45 degrees centigrade is preferable, from 0 to 20 degrees centigrade is more preferable, and from 0 to 15 degrees centigrade is still more preferable. If the receding contact value is within the range described above, the droplet 90 more hardly moves on the functional substrate 1, the effects described above can be more markedly exhibited.

While any specific values of the advancing contact angle B of the self-assembled film 20 with respect to the liquid 90 are particularly not limited to, from 45 to 75 degrees centigrade is preferable, from 50 to 70 degrees centigrade is more preferable, and from 55 to 65 degrees centigrade is still more preferable. If the advancing contact value is within the range described above, the effects described above can be more markedly exhibited.

While any specific values of the static contact angle C of the self-assembled film 20 with respect to the liquid 90 are particularly not limited to, from 30 to 70 degrees centigrade is preferable, from 35 to 60 degrees centigrade is more preferable, and from 40 to 50 degrees centigrade is still more preferable. If the static contact value is within the range described above, the effects described above can be more markedly exhibited.

Method for Manufacturing a Functional Substrate

Next, a method for manufacturing the functional substrate 1 satisfying the relations among contact angles as described above will be described.

The functional substrate 1 is manufactured by the method including a first process performing a first treatment on the substrate body, and a second process forming the self-assembled film 20 on the substrate body 10 on which the first treatment has been performed.

Substrate Body

As the substrate body 10 on which the first treatment is performed, any materials can be applied as long as the molecule included in the self-assembled film 20 (self-assembled molecule that will be described later) is chemically combined with. For example, various kinds of materials such as a silicon wafer, quartz glass, glass, and metal plates can be used. In addition, such various types of raw substrates on the surface of which a semiconductive film, metallic film, dielectric film or the like is formed as an underlayer can also be used as the substrate body 10.

First Process

The first treatment is performed on the substrate body 10 described above (the first process).

Performing the treatment on the substrate body 10 prior to forming the self-assembled film 20 allows, for example, microscopic ridges and valleys or a defective part (defective site) with which the molecule included in the self-assembled film 20 is hardly combined, to be formed on the surface of the substrate body 10. Accordingly, the ease for combining (combined rate or reaction rate) the molecule included in the self-assembled film 20 with the substrate body 10 or its combined amount (combined density) can easily be controlled. Particularly, by reducing the ease of combining the constituent molecule of the self-assembled film 20 with the substrate body 10, a part with which the constituent molecule of the self-assembled film 20 is not combined can be (microscopically) formed on the surface of the substrate body 10 in the second process described later. Here, the constituent molecule of the self-assembled film 20 is simply referred to as the “constituent molecule,” herein after. Namely, the density of the self-assembled film 20 can be lowered. In addition, the constituent molecule having a straight-chain shape hardly stands on the surface of an electrode, increasing the number of laid molecules. As a result, the receding contact angle is markedly lessened whereas the static contact angle or the like remains largely unchanged, thereby enabling the functional substrate 1 satisfying the relations described above to be achieved.

The first process described as above can be carried out with any methods and conditions, but an oxygen plasma treatment is preferably carried out. The oxygen plasma treatment allows ridges and valleys or the defective part (defective site) with which the molecule included in the self-assembled film 20 is hardly combined, to be easily and surely formed on the surface of the substrate body 10, while cleaning the surface of the substrate body 10 as well as thoroughly preventing whole of the substrate body 10 from being damaged.

The first process can be carried out with any methods, though, for example, if a UV ozone treatment is carried out, it is difficult to form microscopic ridges and valleys or the defective part (defective site) even though the surface of the substrate body 10 can be cleaned. This treatment causes the self-assembled film having a uniform surface since the self-assembled film is densely formed on the substrate in the second process described later. As a result, it is difficult to achieve the effects of the invention as described above.

Below, the oxygen plasma treatment serving as the first treatment will be described.

The oxygen plasma treatment can be carried out, for example, by the following manners: using a plasma treatment device, oxygen gas is replaced after depressurizing inside the chamber at approximately 10⁻⁴ Torr; the oxygen plasma is excited by RF oscillating power; and the substrate body 10 is hold in the oxygen plasma.

The flow rate of process gas in the oxygen plasma treatment is preferably, but not particularly limited to, from 10 to 500 sccm, and is more preferably from 50 to 400 sccm. Also, it is still more preferably from 50 to 150 sccm.

The RF intensity is preferably, but not particularly limited to, for example, from 0.005 to 0.2 W/cm², and is more preferably from 0.05 to 1 W/cm². Also is still more preferably from 0.05 to 0.07 W/cm².

The duration of the oxygen plasma treatment is preferably, but not limited to, for example, from 1 to 600 seconds, and is more preferably from 180 to 600 seconds. Also, it is still more preferably from 300 to 600 seconds.

The temperature of the atmosphere in the oxygen plasma treatment is preferably, but not limited to, for example, from 0 to 100 degrees centigrade, and is more preferably from 10 to 50 degrees centigrade. Also, it is still more preferably from 15 to 30 degrees centigrade.

The heating temperature of the substrate body in the oxygen plasma treatment is preferably, but not limited to, for example, from 0 to 100 degrees centigrade, and is more preferably from 10 to 50 degrees centigrade. Also, it is still more preferably from 15 to 30 degrees centigrade.

The conditions set as described above for the oxygen plasma treatment allow microscopic ridges and valleys to be properly formed on the surface of the substrate body 10. The microscopic defective site can be properly formed on which the constituent molecule of the self-assembled film 20 cannot be adsorbed. In contrast, if each of conditions for the oxygen plasma treatment is out from the range described above, the defective site cannot be properly formed on which the constituent molecule of the self-assembled film cannot be adsorbed, possibly resulting in the advantages of the invention being hardly achieved. In contrast, due the defective site excessively formed, the forming of the self-assembled film is possibly prevented.

Second Process

Next, the self-assembled film 20 is formed on the surface of the substrate body 10 on which the first treatment has been performed. The self-assembled film 20, which is generally composed of an organic molecule having a chain structure, is also called as the self-assembled film (a self-assembled monolayer (SAM)). The constituent molecule of the self-assembled film 20 generally includes a functional group able to combine with the substrate, a functional group that modifies the nature of the substrate surface (controls its surface energy) such as a lyophilic or lyophobic functional group and is present at the opposite end of the functional group able to combine with the substrate, and a carbon linear chain or partially branched carbon chains that bind together such functional groups. The constituent molecule combines with the substrate so as to be self-assembled, forming a molecular film, for example, a monomolecular film.

By using, for example, fluoroalkylsilane as the constituent molecule of the self-assembled film 20, each compound is orientated so that the fluoroalkyl group is disposed on the film surface, forming a self-assembled film. As a result, (macroscopically) uniform lyophobicity is provided to the film surface.

Examples of the compound (molecule) forming the self-assembled film as described above include fluoroalkylsilane (hereinafter, referred to as FAS) such as heptadecafluoro-1,1,2,2-tetrahydrodecyl-triethoxysilane, heptadecafluoro-1,1,2,2-tetrahydrodecyl-trimethoxysilane, heptadecafluoro-1,1,2,2-tetrahydrodecyl-trichlorosilane, tridecafluoro-1,1,2,2-tetrahydrooctyl-triethoxysilane, tridecafluoro-1,1,2,2-tetrahydrooctyl-trimethoxysilane, tridecafluoro-1,1,2,2-tetrahydrooctyl-trichlorosilane, trifluoropropyl trimethoxysilane, and compound including SH and fluoro groupes. One of these compounds is preferably used alone, but it is also possible to use two or more of them in combination as long as they do not sacrifice any advantages of the invention. In addition, in the invention, by using the above-described compounds as the compound included in the self-assembled film, adhesiveness of the formed self-assembled film 20 with respect to the substrate body 10 and the lyophobicity can be made exceptional.

The FAS is generally expressed by the structural formula: RnSiX₍₄₋ₙ₎, where n is an integer between one and three inclusive, and X is hydrolytic groups such as a methoxy group, an ethoxy group, and a halogen atom. In addition, R is a fluoroalkyl group having a structure of (CF₃) (CF₂) x (CH₂) y (where, x is an integer between zero and 10 inclusive, and y is an integer between zero and four inclusive). In a case where a plurality of Rs or Xs is combined with Si, it will also be acceptable either for the Rs or the Xs to be the same as one another, or alternatively for them to differ from one another. The hydrolysis group expressed by X makes silanol by hydrolyzing it. The silanol reacts with, for example, a hydroxyl group in the underlayer such as the substrate (glass or silicon), being combined with the substrate by forming a siloxane bond. On the other hand, the R, because it includes the fluoro group such as (CF₃) on its surface, modifies the properties of the surface of the underlayer such as the substrate into an unwettable surface (having low surface energy and high lyophobicity).

In addition, examples of the compounds including the SH and fluoro groups (hereinafter, simply referred to as a thiol compound) include, for example, compounds expressed by the following general formula: CF₃(CF₂)m(CF₂)nSH, where m is an integer between one and 35 inclusive, and n is an integer between two and 33 inclusive.

In the general formula, m/n is preferably from 0.25 to 18, and more preferably from 0.25 to 10. Also, it is still more preferable from one to seven. As a result, the compound expressed by the above-described general formula can exhibit exceptionally high lyophobicity since the ratio of fluoro group occupied in the molecule structure increases sufficiently.

In the thiol compound, the number of carbons is preferably from four to 45, and more preferably from 10 to 42.

As the thiol compound, for example, saturated hydrocarbons including the SH group or derivatives of the saturated hydrocarbons can be used in addition to those described above. An example of the derivatives includes one in which, for example, an OH group, an NH₂ group, a COOH group or the like is introduced to the end part opposite of the SH group.

The self-assembled film 20 can be formed by any of methods or conditions as the second process.

A method and conditions for forming the self-assembled film 20 composed of the FAS by a chemical vapor deposition method will be typically described below.

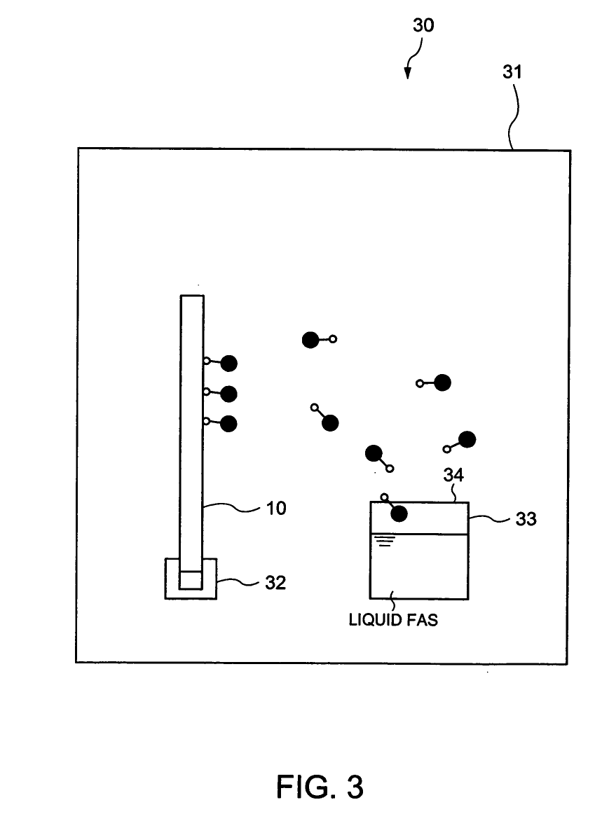

FIG. 3 is a structural view schematically illustrating a FAS treatment device 30 for the chemical vapor deposition method. The FAS treatment device 30 forms the self-assembled film 20 composed of the FAS on the substrate body 10. As shown in FIG. 3, the FAS treatment device 30 includes a chamber 31, a substrate holder 32 that is disposed in the chamber 31 and holds the base body 10, and a container 33 containing the FAS in a liquid phase state (liquid FAS). The substrate holder 32 holds the substrate body 10 with a part thereof, which excludes a region on which a pattern is formed. The substrate body 10 and the container 33 containing the liquid FAS are left in the chamber 31 under a room temperature environment. The liquid FAS in the container 33 is emitted as a gas phase from an opening part 34 of the container 33 to the chamber 31. Within about two or three days, for example, the self-assembled film 20 composed of the FAS is formed on the substrate body 10. In addition, by maintaining the whole chamber 31 at approximately 100 degrees centigrade, the self-assembled film 20 also can be formed on the substrate body 10 within about three hours.

Here, FIG. 1 is a schematic view illustrating the surface condition of the substrate body 10 in a case where the fluoroalkylsilane (FAS) is used as the compound forming the self-assembled film 20. As shown in FIG. 1, the self-assembled film 20 is formed by orientating the compound so that the fluoroalkyl group is positioned at its outer surface side. Since microscopic ridges and valleys are formed on the substrate body 10 on which the oxygen plasma treatment (the first process) has been performed, the fluoroalkylsilane is randomly oriented by following the shape of the ridges and valleys. In addition, the defective site on which the fluoroalkylsilane cannot be adsorbed is properly formed, lowering the density of the self-assembled film 20. Accordingly, the receding contact angle with respect to the droplet can be lessened while maintaining the functionality of the molecule. As a result, the receding contact angle can be lowered even if the static contact angle or advancing angle is large. This makes it possible to apply (provide) a given droplet preferably on a substrate (functional substrate) in the liquid process for example. In addition, the adsorption amount of the self-assembled film 20 is lessened due to the presence of the defective site, lowering the density of the self-assembled film 20. As a result, the effect can be more exhibited.

The maximum thickness of the self-assembled film 20 is preferably smaller than the length from a bonding group to a substituent group of the organic compounds. This allows the effects described above to be more markedly exhibited.

Performing the chemical vapor deposition under the conditions as described above leaves a part with which the constituent molecule is able to combine, enabling the effects described above to be more markedly exhibited. In contrast, if the above-described conditions are not satisfied, the self-assembled film 20 is not thoroughly formed, possibly resulting in the static contact angle with respect to the droplet being kept small, or the self-assembled film 20 is densely formed, possibly resulting in the receding contact angle with respect to the droplet being large.

In addition, the self-assembled film 20 can also be formed, for example, by contacting a liquid containing the constituent molecule of the self-assembled film 20 (liquid for forming a self-assembled film) on the surface of the substrate body 10 on which the oxygen plasma treatment (the first treatment) has been performed.

As the method for contacting the liquid for forming a self-assembled film on the surface of the substrate body 10, for example, the following methods can be used: a method of soaking the substrate body 10 into a liquid for forming an organic film; a method of spraying the liquid for forming an organic film to the substrate body 10; and a method of contacting the substrate body 10 to the liquid for forming an organic film.

As the solvent for preparing the treatment liquid, one or mixture of the following exemplified solvents can be used: ethanol, chloroform, dichloromethane, dimethylformamide, 1,4-dioxane, butyl acetate, xylene, propanol, and water.

The processing time of the second process is preferably set so as to satisfy the following condition 1. Condition 1: the number of self-assembled molecules combined with the surface of the substrate body 10 is preferably about from 0.01×10¹⁵ to 1×10¹⁵ pieces/cm², more preferably about 0.1×10¹⁵ to 1×10⁵ pieces/cm², and still more preferably 0.5×10¹⁵ to 0.95×10¹⁵ pieces/cm².

In the functional substrate 1, which is manufactured as described above, of the invention, the constituent molecules of the self-assembled film 20 is considerably occupied with molecules laid on the substrate body 10, resulting in the density of the self-assembled film 20 formed on the surface being relatively low. This allows the receding contact angle with respect to the droplet to be lowered in a case where a fine pattern is formed by using the functional substrate with the droplet method. As a result, even if the static contact angle or the like is large, for example, the occurrence of the wire breakage or bulge can effectively be prevented, thereby enabling fine and thin film patterns to be formed.

Moreover, when the functional characteristics of the self-assembled film are paid attention, a high functional self-assembled film can preferably be used in the liquid process with employing the method even if the self-assembled film shows poor wettability.

Method for Forming a Fine Pattern

Next, a method for forming a fine pattern on the functional substrate by using the functional substrate of the invention will be described below. While the method for forming a conductive film wiring will be described below as an example of the method for forming a fine pattern according to the invention, the invention can also be applied to a case in which a fine pattern excluding the conductive film wiring is formed. Here, in the invention, the term “fine pattern” means one having a sufficiently fine pattern such as a pattern to be formed including a part having a line width of 100 μm and below.

The method for forming a conductive film wiring (fine pattern) according to the embodiment of the invention includes a discharge process in which a dispersion liquid (liquid) containing a conductive fine particle is discharged on to the surface (the surface on which the self-assembled film has been disposed) of the functional substrate as a droplet with a given pattern, and a dispersion medium removing process to remove the dispersion medium included in the discharged dispersion liquid.

Discharging Liquid (Dispersion Liquid)

First, the liquid (discharging liquid) discharged on the functional substrate will be described.

As for the discharging liquid, any liquid can be used as long as its droplet satisfies the above-described relation of contact angle with respect to the surface of the self-assembled film 20 of the functional substrate 1.

In the embodiment, the dispersion liquid in which the conductive fine particle is dispersed in the dispersion medium is used as the discharging liquid.

As for the conductive fine particle included in the dispersion liquid, a fine particle (metallic fine particle) including gold, silver, copper, palladium, nickel or the like, a fine particle composed of a conductive polymer, a fine particle composed of a super-conducting material, etc., are exemplified. These conductive fine particles can also be used with their surfaces coated with an organic matter in order to improve their dispersibility.

The average diameter of the conductive fine particles is preferably from 1 nm to 0.1 μm. If the average diameter of the conductive fine particles exceeds the upper limit described above, nozzles are eased to be clogged in the discharging process described later, possibly resulting in the discharge by the inkjet method being difficult.

The dispersion medium included in the dispersion liquid, not particularly limited to, preferably has a vapor pressure of from 0.001 to 200 mmHg (about 0.133 to 26600 Pa) in the room temperature, and more preferably from 0.001 to 50 mmHg (about 0.133 to 6650 Pa). The vapor pressure below the lower limit causes drying time to increase, resulting in the dispersion medium being easily left in the film. As a result, it is difficult to achieve a conductive film with good quality even if the dispersion medium removing process is performed later. In contrast, the vapor pressure above the upper limit easily causes the nozzle clogging due to the drying when the droplet is discharged by the inkjet method, possibly resulting in the stable discharge being difficult.

As for the dispersion medium included in the dispersion liquid, any dispersion medium can be used as long as the conductive fine particles described above can be dispersed into it. One or mixture of more than one chosen from the following exemplified dispersion mediums can be used: water, alcohols such as methanol, ethanol, propanol and butanol; hydrocarbon based compounds such as n-heptane, n-octane, decane, dodecane, tetradecane, hexadecane, toluene, xylene, cymene, durene, indene, dipentane, tetrahydronaphthalene, decahydronaphthalene and cyclohexylbenzene; ether based compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether and p-dioxane; and polar compounds such as propylene carbonate, y-butyrolactone, N-methyl-2-pyrrolidone, dimethylformamide, dimethylsulfoxide and cyclohexanone. Among them, water, alcohols, hydrocarbon compounds, and ether compounds are preferably used in terms of fine particle dispersibility, dispersion liquid stability, and applicability to the inkjet method. Water and hydrocarbon compounds are more preferably used.

The concentration of a dispersoid in the dispersion liquid differs depending on the film thickness of the conductive film to be formed. It is preferable from 1% to 80% by mass.

The surface tension of the dispersion liquid is preferably from 0.02 to 0.07 N/m. If the surface tension of the dispersion liquid is below the lower limit, the wettability of the dispersion liquid with respect to a nozzle surface increases, easily causing a deviation in flight path when the droplet is discharged by the inkjet method. In contrast, if the surface tension of the dispersion liquid is above the upper limit, the shape of a meniscus at the end of nozzle is not stable, possibly resulting in the discharging quantity and timing being difficult to be controlled.

In order to adjust the surface tension, a surface tension regulator such as fluorine, silicone, or nonion group can be added in the dispersion liquid. The nonionic surface tension regulator serves to enhance the wettability of the liquid to the substrate, improves leveling of the film, and prevents the occurrence of minute bumps in the coated film.

The viscosity of the dispersion liquid is preferably from 0.5 to 50 mPa·s. If the viscosity of the dispersion, liquid is below the lower limit, the peripheral part of nozzle is easily contaminated by spilt dispersion liquid when the discharge is carried out by the inkjet method. In contrast, if the viscosity of the dispersion liquid is over the upper limit, the nozzle is frequently clogged, possibly resulting in the smooth discharge of the droplet being difficult.

Discharge Process

The dispersion liquid (liquid) as described above is discharged on the surface (the surface on which the self-assembled film 20 has been disposed) of the functional substrate 1 (discharge process).

In the embodiment, a case will be described in which a fine pattern including a thin line having a width of from 20 to 60 μm is formed. Firstly, the droplet of the dispersion liquid is discharged from an inkjet head so that the droplet is given as a pattern corresponding to a fine pattern to be formed in the wiring forming region on the substrate.

As for the discharging method of the inkjet, a piezo-jet method discharging the liquid material by changing the volume of a piezoelectric element, and a method in which a liquid material is discharged by vapor rapidly generated by applied heat may be used.

Dispersion Medium Removing Process

Drying to remove the dispersion medium may follow the discharge of droplets on the whole of wiring forming region, if necessary. The drying can be carried out as a natural drying, or by a treatment such as a hot plate, electric furnace, etc., or lamp annealing. Examples of light sources for the lamp annealing include: an infrared lamp, a xenon lamp, a YAG laser, an argon laser, a carbon dioxide laser, and an excimer laser of XeF, XeCl, XeBr, KrF, KrCl, ArF, ArCl, or the like. Such light sources are typically used within the range of from 10 to 5000 W, but in the embodiment, within the range of from 100 to 1000 W is adequate.

In this case, the degree of heating or light irradiation is allowed to increase so as not only to remove the dispersion medium but also to convert the dispersion liquid into the conductive film. The drying can also be carried out in parallel with the discharge at the same time. For example, the drying can start once the droplet, which includes the dispersion medium having a low boiling point, is landed on the functional substrate by discharging the droplet on the heated substrate or by using a cooled inkjet head. The droplet becomes a dried film after the drying. The dried film, of which the volume is markedly reduced and the viscosity is increased by removing the dispersion medium, is easily fixed at a given position in the wiring forming region.

The conductive film formed by the embodiment can be formed with a width that is roughly equal to the diameter of a single droplet of the dispersion liquid after landing on the substrate. In addition, a desired film thickness can be achieved while maintaining the line width. According to the embodiment, a thin line and a thick film can be achieved without the occurrence of the bulge. Consequently, according to the embodiment, a conductive film wiring can be formed that has a thick film that is advantageous for electric conduction and hardly causes the defects such as the wire breakage or short, and further can be formed fine.

Next, an electro-optical device of the invention will be described with a few examples.

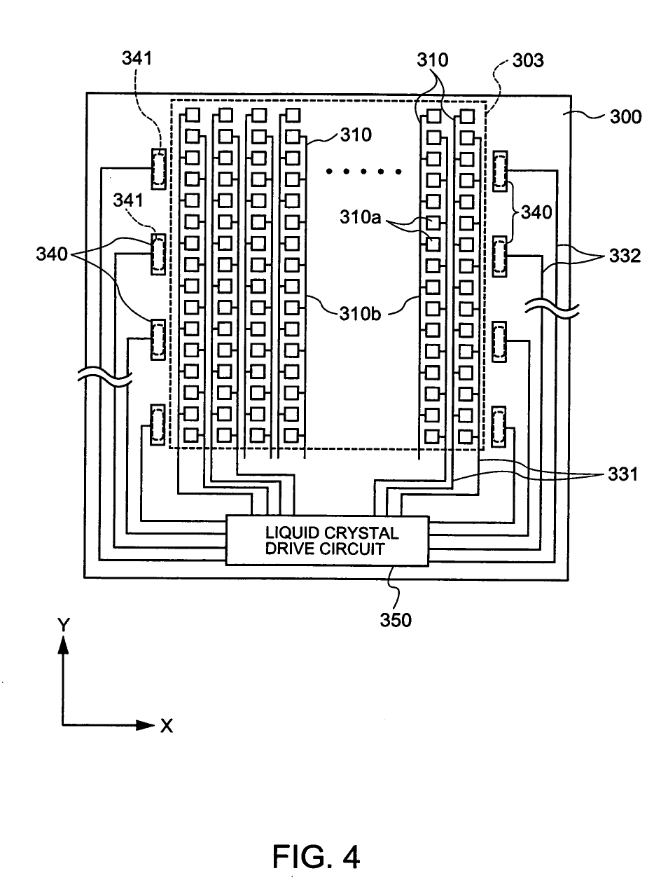

First, a liquid crystal device will be described as an example of the electro-optical device of the invention. FIG. 4 shows a plan layout of a signal electrode or the like on a first substrate of the liquid crystal device according to the embodiment. The liquid crystal device of the embodiment is mainly composed of the first substrate 300, a second substrate (not shown) provided with a scanning electrode or the like, and liquid crystal (not shown) sealed between the first and second substrates.

As shown in FIG. 4, a plurality of signal electrodes 310 is provided in a multiplex matrix arrangement in a pixel region 303 on a first substrate 300. Particularly, each of the signal electrodes 310, which is composed of a plurality of pixel electrode parts 310a each of which corresponds to a respective pixel, and a signal wiring part 310b connecting the pixel electrode parts 310a in a multiplex matrix arrangement, is extended in the Y direction. A liquid crystal drive circuit 350 has a single-chip structure. The liquid crystal drive circuit 350 and one end (lower side of the FIG. 4) of the signal wiring part 310b are connected via a first leading wiring 331. A vertical conducting terminal 340 is connected via a vertical conductor 340 to a terminal provided on the second substrate not shown. The vertical conducting terminal 340 is connected to the liquid crystal drive circuit 350 via a second lead wiring 332.

In the embodiment, the functional substrate of the invention is used as the first substrate 300. Each of the signal wiring part 310b, the first leading wiring 331, and the second leading wiring 332 that are disposed on the first substrate 300, is formed by the method for forming a fine pattern of the invention as described above. According to the liquid crystal device of the embodiment, the liquid crystal device, in which the defect such as the wire breakage or short of each of the above-described wirings hardly occurs, allows it to be small and thin.

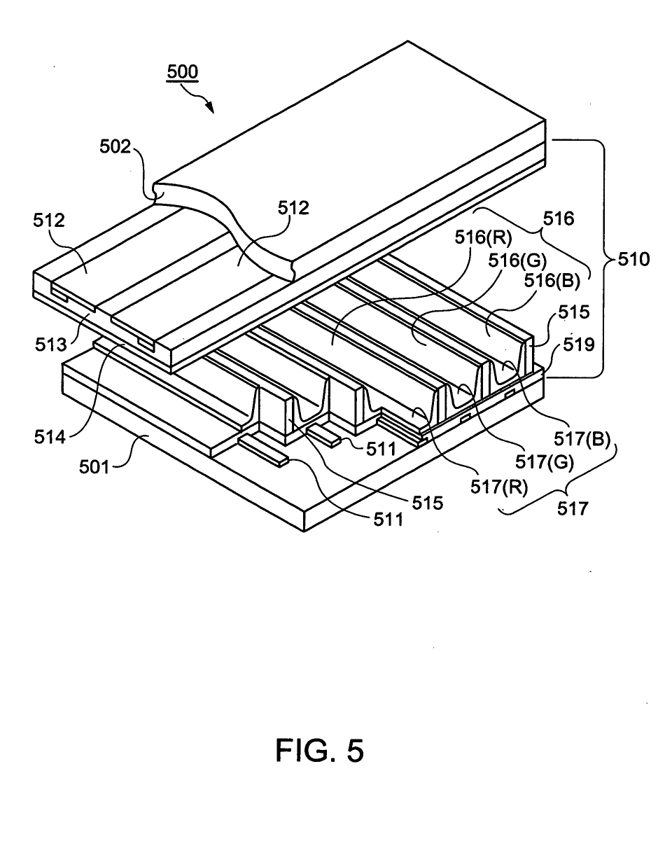

Next, a plasma display device will be described as an example of the electro-optical device of the invention. FIG. 5 is an exploded perspective view of a plasma display device 500 of the embodiment. The plasma display 500 of the embodiment is mainly composed of glass substrates 501 and 502 disposed so as to face each other, and a discharge display part 510 formed between the substrates. The discharge display part 510 is composed of a plurality of discharge cells 516 integrated with each other, and the plurality of discharge cells 516 is arranged so that three discharge cells, which are a red discharge cell 516(R), a green discharge cell 516(G), and a blue discharge cell 516(B), form one pixel. An address electrode 511 is formed on the upper surface of the (glass) substrate 501 with a predetermined interval to form stripes, and a dielectric layer 519 is formed so as to cover the address electrode 511 and the upper surface of the substrate 501, and further, a partition 515 formed on a dielectric layer 519 is located between the address electrodes 511 and along each of the address electrodes 511. Note that, the partition 515 is divided (not shown in FIG. 5) at a predetermined position in the longitudinal direction by a predetermined interval in a direction perpendicular to the address electrode 511, and basically, a rectangular region defined by partitions adjacent to both the right and the left sides in the width direction of the address electrode 511 and the partitions extended in a direction perpendicular to the address electrode 511 is formed. The discharge cell 516 is formed so as to correspond to the rectangular region, and one pixel is formed of three of these rectangular regions. In addition, a fluorescent material 517 is disposed inside the rectangular region zoned by the partition 515. The fluorescent material 517 emits fluorescence of one of red, green, and blue, and a red fluorescent material 517(R) is disposed on the bottom of the red discharge cell 516(R), and a green fluorescent material 517(G) is disposed on the bottom of the green discharge cell 516(G), and a blue fluorescent material 517(B) is disposed on the bottom of the blue discharge cell 516(B).

Next, a plurality of display electrodes 512 is formed on the glass substrate 502 in the direction perpendicular to the address electrode 511 with a predetermined interval to form stripes. A dielectric layer 513 is formed so as to cover the plurality of display electrodes 512. Further, a protective film 514 composed of MgO or the like is formed on the dielectric layer 513. Then, the substrate 501 and glass substrate 502 are faced and bonded each other so that the address electrode 511 and the display electrode 512 are perpendicular each other. Subsequently, the space enclosed by the substrate 501, the partition 515, and the protective layer 514 formed on the glass substrate 502 is exhausted and filled with noble gas to complete the discharge cell 516. Two display electrodes 512 formed on the glass substrate 502 are disposed for each discharge cell 516. The address electrode 511 and the display electrode 512 are connected to an alternate current power supply source not shown in FIG. 5. The fluorescent member 517 is excited to emit light at a required position of the discharge display part 510 by applying electricity to the respective electrodes, presenting a color display.

In the embodiment, the functional substrate of the invention is used as the glass substrates 501and 502, and the address electrode 511 and the display electrode 512 are formed by the method for forming a fine pattern of the invention. According to the plasma display device of the embodiment, the plasma display device, in which the defect such as the wire breakage or short of each of the above-described wirings hardly occurs, allows it to be small and thin.

In the examples of the electro-optical device, the liquid crystal device and plasma display device are exemplified. However, the electro-optical device of the invention is not limited to the above-described examples, but can be applied to organic EL devices including an organic EL element, electrophoretic devices including an electrophoretic element, surface-conduction display devices including a surface-conduction electron emission element, etc., in addition to the liquid crystal device. Specifically, the structure and process of the functional substrate described above can be applied to those electro-optical devices in a similar manner.

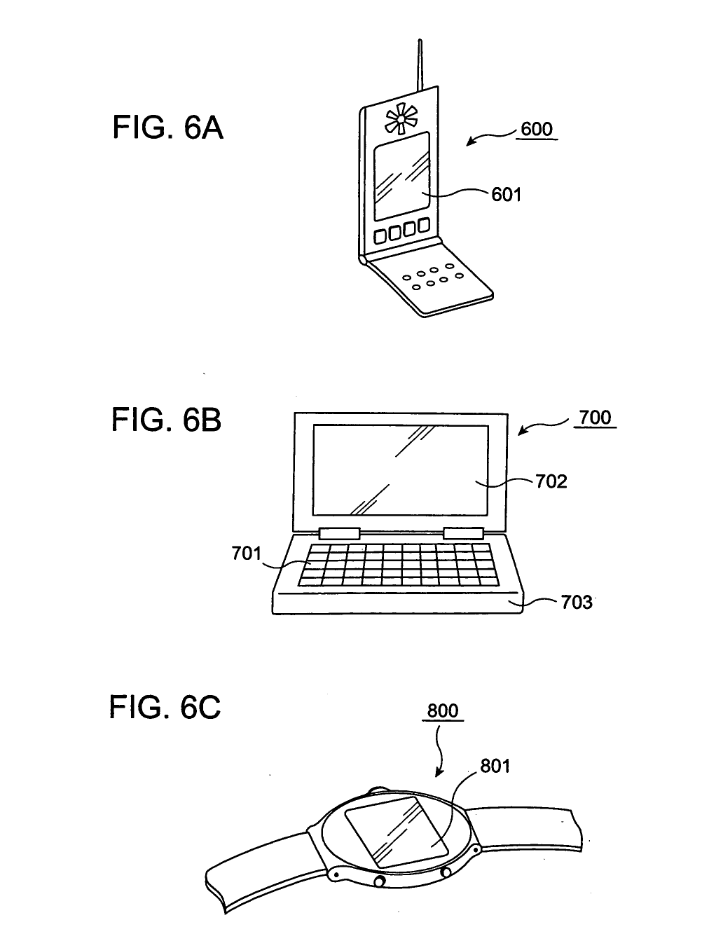

Next, specific examples of an electronic apparatus of the invention will be described. FIG. 6A is a perspective view illustrating an example of cellular phones. In FIG. 6A, a cellular phone 600 includes a liquid crystal display 601 having the liquid crystal device described above with reference to FIG. 4.

FIG. 6B is a perspective view illustrating an example of portable information processors such as word processors and personal computers. In FIG. 6B, an information processor 700 includes an input unit 701 such as a keyboard, an information processor body 703, and a liquid crystal display 702 having the liquid crystal device described above with reference to FIG. 4.

FIG. 6C is a perspective view illustrating an example of wristwatch type electronic apparatuses. In FIG. 6C, a wristwatch 800 includes a liquid crystal display 801 having the liquid crystal device described above with reference to FIG. 4.

Since the electronic apparatuses shown in FIGS. 6A through 6C include the liquid crystal device of the above-described embodiment, the electronic apparatuses, in which the defects such as the wire breakage or short of wirings hardly occurs, allow them to be small and thin.

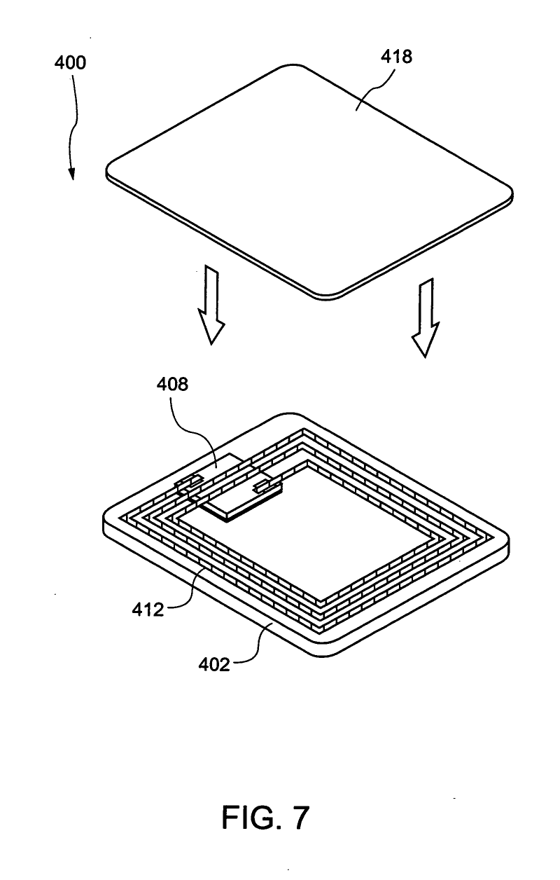

Next, another embodiment of a non-contact card medium will be described as another example of the electronic apparatus of the invention. As shown in FIG. 7, a non-contact card medium 400 according to the embodiment includes a semiconductor integrated circuit chip 408 and an antenna circuit 412 housed in a case composed of a card base 402 and a card cover 418. The medium supplies electric power or communicates with data to an outside transceiver (not shown) by using electromagnetic wave or electrostatic capacity coupling.

The functional substrate of the invention is used to form the card base 402. According to the non-contact card medium of the embodiment, the non-contact card medium, in which the defect such as the wire breakage or short of the antenna circuit 412 hardly occurs, allows it to be small and thin.

The invention is described as above based on the embodiments. However, the invention is not limited to the embodiments.

The shapes, the combinations or the like of the components described in the above embodiments are an example, and various modifications can be made based on a design demand or the like without departing from the gist of the invention.

In the above-described embodiments, the self-assembled film is formed by the chemical vapor deposition method. However, the method for forming a self-assembled film is not limited to this. For example, the self-assembled film may be allowed to be formed from a liquid phase. For example, a self-assembled film may be allowed also to be formed on a substrate body by soaking the substrate body into a solution containing a material compound, and then washing and drying the substrate body.

In the above-described embodiments, the droplet is discharged by the inkjet method when forming the thin film pattern. However, the method for discharging a droplet is not limited to this.

### EXAMPLES

### Example 1

Sample No. 1-1 to 1-4

A silicon substrate on which gold had been vapor deposited (hereinafter, simply referred to as silicon substrate) was prepared. Then it was subjected to an organic cleaning. Specifically, the silicon substrate was subjected to an ultra sonic cleaning for 5 minutes twice in acetone. Then, the silicon substrate was subjected to an ultra sonic cleaning for 5 minutes twice in propanol. After the cleaning, the silicon substrate was taken out, and then dried by dry air.

Next, an oxygen plasma treatment was performed to the silicon substrate. Specifically, using a plasma treatment device commercially available, plasma discharge was carried out under the following conditions: substrate temperature was 25 degrees centigrade; surrounding temperature was 25 degrees centigrade; oxygen gas (process gas) flow rate was 100 sccm; pressure was 1×10⁻¹ Pa; and RF intensity was 0.05 W/cm². The oxygen plasma treatment was carried out for 10 minutes.

The surface of gold on the silicon substrate, which had been treated by the oxygen plasma treatment, was treated with fluorinated thiol, forming a self-assembled film. As a result, a functional substrate was achieved. This surface treatment was carried out by soaking the silicon substrate, which had been treated by the oxygen plasma, into chloroform solution containing 0.1 mmol of 2-(perfluorodecyl)ethanethiol (CF₃(CF₂)₉(CH₂)SH) as the fluorinated thiol. The soaking time was set as shown in Table 1.

Sample No. 1-5 to 1-8

The silicon substrate on which gold had been vapor deposited (hereinafter, simply referred to as silicon substrate) was prepared. Then it was subjected to the organic cleaning. Specifically, the silicon substrate was subjected to the ultra sonic cleaning for 5 minutes twice in acetone. Then, the silicon substrate was subjected to the ultra sonic cleaning for 5 minutes twice in propanol. After the cleaning, the silicon substrate was taken out, and then dried by dry air.

Then, a UV ozone treatment was performed to the silicon substrate. Specifically, using a UV treatment device commercially available, the UV ozone treatment was carried out under the condition in which the ultraviolet ray intensity was 10 mW/cm² (at 254 nm). Each UV ozone treatment was carried out for 10 minutes.

The surface of gold on the silicon substrate, which had been treated by the UV ozone treatment, was treated with fluorinated thiol, forming a self-assembled film. As a result, a functional substrate was achieved. This surface treatment was carried out by soaking the silicon substrate treated by the UV treatment into chloroform solution containing 0.1 mmol of 2-(perfluorodecyl)ethanethiol (CF₃(CF₂)₉(CH₂)SH) as the fluorinated thiol. The soaking time was set as shown in Table 1.

The functional substrates that had been made as described above were subjected to measure contact angles (static contact angle, receding contact angle, and advancing contact angle) with respect to a droplet of the liquid used in example 2 described later. The results are shown in Table 1.

TABLE 1

| | | Sample No. | | | | | | | |
|---|---|---|---|---|---|---|---|---|---|
| | | 1-1 | 1-2 | 1-3 | 1-4 | 1-5 | 1-6 | 1-7 | 1-8 |
| 1^{st} | Treatment | OX | OX | OX | OX | UV | UV | UV | UV |
| | Temperature [degree | 25 | 25 | 25 | 25 | 25 | 25 | 25 | 25 |
| | centigrade] | | | | | | | | |
| | RF intensity [W/cm²] | 0.1 | 0.1 | 0.1 | 0.1 | 0.01 | 0.01 | 0.01 | 0.01 |
| | Gas flow rate [sccm] | 100 | 100 | 100 | 100 | N/A | N/A | N/A | N/A |
| | Process time [minute] | 10 | 10 | 10 | 10 | 10 | 10 | 10 | 10 |
| 2^{nd} | Process time [minute] | 0 | 5 | 30 | 1440 | 0 | 5 | 30 | 1440 |

| | | | | | | | | |
|---|---|---|---|---|---|---|---|---|
| Contact angle A [degree] | 0 | 0 | 14.1 | 41.0 | 0 | 44.3 | 50.4 | 57.6 |
| Contact angle B [degree] | 0 | 18.8 | 60.2 | 69.6 | 0 | 54.7 | 70.5 | 73.7 |
| Contact angle C [degree] | 0 | 15.5 | 46.1 | 62.7 | 0 | 48.2 | 56.8 | 63.1 |
| A/B | 0 | 0 | 0.23 | 0.58 | 0 | 0.81 | 0.71 | 0.78 |
| A/C | 0 | 0 | 0.31 | 0.65 | 0 | 0.92 | 0.89 | 0.91 |
| C − [(A + B)/2] | 0 | 6.10 | 8.95 | 7.40 | 0 | −1.3 | −3.65 | −2.55 |

Note:
Sample No. 1-2, 1-3, 1-4: Present Invention
Sample No. 1-1, 1-5, 1-6, 1-7, 1-8: Comparative Example
OX: Oxygen Plasma
UV: UV Ozone
1^{st}: First Process
2^{nd}: Second Process

As shown in Table 1, the functional substrates satisfying the given relation among the receding contact angle, advancing contact angle, and static contact angle were obtained by conducting the first and second processes under the given conditions.

### Example 2

Using each of the functional substrates that had been manufactured in the example 1, toluene solution containing a polyfluorene derivative was coated on each of the functional substrates by spin coating, and then dried to remove the toluene.

The surface of the substrate that had been coated with the polymer solution as described above was examined whether a polymer film was formed or not. Specifically, the polymer film was scratched with tweezers so as to pull up the polymer film to confirm whether the film had been formed on the substrate or not. The film was evaluated based on the following three levels.

Good: polymer thin film having uniform a thickness was preferably formed.

Average: polymer thin film was formed in island forms without having a uniform thickness.

Poor: no polymer thin film was formed.

The results are shown in Table 2.

TABLE 2

| Sample No. | Evaluation Result |
|---|---|
| 1-1 Comparative example | Poor |
| 1-2 Present invention | Average |
| 1-3 Present invention | Good |
| 1-4 Present invention | Average |
| 1-5 Comparative example | Poor |
| 1-6 Comparative example | Poor |
| 1-7 Comparative example | Poor |
| 1-8 Comparative example | Poor |

It can be seen from Tables 1 and 2 that using the functional substrate of the invention allowed the thin film having a uniform thickness to be formed. In contrast, the functional substrate shown as the comparative example allowed no thin film to be preferably formed.

### Example 3

Sample No. 3-1 to 3-4

A glass substrate was prepared. Then, it was subjected to the organic cleaning. Specifically, the glass substrate was subjected to an ultra sonic cleaning for 5 minutes twice in acetone. Then, the glass substrate was subjected to an ultra sonic cleaning for 5 minutes twice in propanol. After the cleaning, the glass substrate was taken out, and then dried by dry air.

Then, an oxygen plasma treatment was performed to the glass substrate. Specifically, using a plasma treatment device commercially available, plasma discharge was carried out under the following conditions: substrate temperature was 25 degrees centigrade; surrounding temperature was 25 degrees centigrade; oxygen gas (process gas) flow rate was 100 sccm; pressure was 1×10⁻¹ Pa; and RF intensity was 0.05 W/cm². The oxygen plasma treatment was carried out for 10 minutes.

The surface of the glass substrate that had been treated by the oxygen plasma treatment was subjected to a silane coupling agent treatment, forming a self-assembled film. As a result, a functional substrate was achieved. This surface treatment was carried out by heating a sealed container in which the glass substrate and FAS17 ((heptadecafluoro-1,1,2,2-tetra-hydrpdecyl)tri methoxy silane) serving as the silane coupling agent were put together, at 120 degrees centigrade in an oven. The heating time was set as shown in Table 3. As a result, the FAS 17 was vaporized and chemically adsorbed on the surface of the glass substrate, forming a self-assembled film.

On the resulting functional substrate, a conductive wiring (designed line width: 25 μm) was drawn by the inkjet method with using silver colloidal ink (dispersion liquid). Tetradecane was used as the dispersion medium included in the dispersion liquid. The average particle diameter of the dispersoids in the dispersion liquid was 10 nm. The discharged volume of the droplet was approximately 2 pl (average particle diameter: 15.6 μm) per one dot. The viscosity of the dispersion liquid was 3 mPa·s. The surface tension of the dispersion liquid was 0.040 N/m.

Then, the conductive wiring having a fine pattern made of silver was formed by heating to remove the dispersion medium.

Sample No. 3-5 to 3-8

The glass substrate was prepared. Then, it was subjected to the organic cleaning. Specifically, the glass substrate was subjected to the ultra sonic cleaning for 5 minutes twice in acetone. Then, the glass substrate was subjected to the ultra sonic cleaning for 5 minutes twice in propanol. After the cleaning, the glass substrate was taken out, and then dried by dry air.

Then, a UV ozone treatment was performed to the glass substrate. Specifically, using a UV treatment device commercially available, the UV ozone treatment was carried out under the condition in which the ultraviolet ray intensity was 10 mW/cm² (at 254 nm). The UV ozone treatment time was set as shown in Table 3.

The surface of the glass substrate, which had been treated by the UV ozone treatment, was subjected to the silane coupling agent treatment, forming a self-assembled film. As a result, a functional substrate was achieved. This surface treatment was carried out by heating a sealed container in which the glass substrate and a container housing FAS17 ((heptadecafluoro-1,1,2,2-tetra-hydrpdecyl)tri methoxy silane) serving as the silane coupling agent were put together, at 120 degrees centigrade in an oven. The heating time was set as shown in Table 3. As a result, the FAS 17 was vaporized and chemically adsorbed on the surface of the glass substrate, forming a self-assembled film.

On the resulting functional substrate, the conductive wiring (designed line width: 25 μm) was drawn by the inkjet method with using the silver colloidal ink (dispersion liquid) in the same manner as that of sample No. 3-1 to 3-4. Then, the conductive wiring having a fine pattern made of silver was formed by heating to remove the dispersion medium.

The formed condition of the conductive film wiring was observed on each of the functional substrates described above, being evaluated based on the following four levels.

Very good: conductive film wiring having no wire breakage or short was preferably formed without the occurrence of a bulge.

Good: conductive film wiring having no wire breakage or short was formed with a few bulges.

Average: bulge was observed as well as wire breakage or short was found in the formed conductive film wiring.

Poor: no conductive film wiring was formed.

The results are shown in Table 3 with the measurement of contact angles (static contact angle, receding contact angle, and advancing contact angle) of the silver colloidal ink with respect to the droplet, and the thickness and line width of the conductive film thickness.

TABLE 3

| | | Sample No. | | | | | | | |
|---|---|---|---|---|---|---|---|---|---|
| | | 3-1 | 3-2 | 3-3 | 3-4 | 3-5 | 3-6 | 3-7 | 3-8 |
| 1^{st} | Treatment | OX | OX | OX | OX | UV | UV | UV | UV |
| | Temperature [degree | 25 | 25 | 25 | 25 | 25 | 25 | 25 | 25 |
| | centigrade] | | | | | | | | |
| | RF intensity [W/cm²] | 0.05 | 0.05 | 0.05 | 0.05 | N/A | N/A | N/A | N/A |
| | Gas flow rate [sccm] | 100 | 100 | 100 | 100 | N/A | N/A | N/A | N/A |
| | Process time [minute] | 10 | 10 | 10 | 10 | 10 | 10 | 10 | 10 |
| 2^{nd} | Process time [minute] | 0 | 5 | 30 | 120 | 0 | 5 | 30 | 120 |

| | | | | | | | | |
|---|---|---|---|---|---|---|---|---|
| Contact angle A [degree] | 0 | 11 | 14 | 13 | 0 | 34.0 | 36.2 | 50.8 |
| Contact angle B [degree] | 0 | 51.9 | 56.7 | 74.2 | 0 | 58.3 | 62.3 | 75.8 |
| Contact angle C [degree] | 0 | 40.5 | 45.8 | 66.3 | 0 | 40.5 | 49.5 | 66.3 |
| A/B | 0 | 0.21 | 0.25 | 0.24 | 0 | 0.58 | 0.58 | 0.67 |
| A/C | 0 | 0.27 | 0.30 | 0.27 | 0 | 0.84 | 0.73 | 0.77 |
| C − [(A + B)/2] | 0 | 9.05 | 10.45 | 20.2 | 0 | −5.65 | −0.25 | 3 |
| Evaluation | Poor | Good | V.G. | Ave. | Poor | Poor | Poor | Poor |

Note:
Sample No. 3-2, 3-3, 3-4: Present Invention
Sample No. 3-1, 3-5, 3-6, 3-7, 3-8: Comparative Example
OX: Oxygen Plasma
UV: UV Ozone
1^{st}: First Process
2^{nd}: Second Process
V.G.: Very Good
Ave.: Average

It can be seen from Table 3 that the invention allowed a fine pattern (conductive film wiring) having a uniform thickness and line width to be formed. In contrast, the comparative example allowed no fine pattern to be preferably formed.

What is claimed is:

1. A method of manufacturing a functional substrate on which a film being to be formed by applying a liquid material, comprising:
forming a first portion on a base board by performing a first treatment to the base board; and
forming a self-assembled film at least on the first portion, a receding contact angle of the self-assembled film with respect to the liquid material being A, an advancing contact angle of the self-assembled film with respect to the liquid material being B, a treatment condition of the first treatment and a forming condition of the self-asembled film being set so as to satisfy a relation of A/B≦0.60.

2. A method of manufacturing a functional substrate on which a film being to be formed by applying a liquid material, comprising:
forming a first portion on a base board by performing a first treatment to the base board; and
forming a self-assembled film at least on the first portion, a receding contact angle of the self-assembled film with respect to the liquid material being A, a static contact angle of the self-assembled film with respect to the liquid material being C, a treatment condition of the first treatment and the forming condition of the self-assembled film being set so as to satisfy a relation of A/C≦0.70.

3. A method of manufacturing a functional substrate on which a film being to be formed by applying a liquid material, comprising:
forming a first portion on a base board by performing a first treatment to the base board; and
forming a self-assembled film at least on the first portion, a receding contact angle of the self-assembled film with respect to the liquid material being A, an advancing contact angle of the self-assembled film with respect to the liquid material being B, a static contact angle of the self-assembled film with respect to the liquid material being C, a treatment condition of the first treatment and a forming condition of the self-assembled film being set so as to satisfy a relation of C−[(A+B)/2]≧5.0.

4. The method of manufacturing a functional substrate according to claim 1, the first treatment including irradiating the base board with an oxygen plasma.

5. The method of manufacturing a functional substrate according to claim 1, the first treatment including irradiating the base board with an oxygen plasma, a radio frequency intensity in the oxygen plasma being from 0.005 to 0.2 W/cm².

6. The method of manufacturing a functional substrate according to claim 1, the first treatment including irradiating the base board with an oxygen plasma, a flow rate of process gas in the oxygen plasma being from 10 to 500 sccm.

7. The method of manufacturing a functional substrate according to claim 1, the first treatment including irradiating the base board with an oxygen plasma, a temperature of an atmosphere in the oxygen plasma treatment being from 0 to 100 degrees centigrade.

8. The method of manufacturing a functional substrate according to claim 1, the first treatment including irradiating the base board with an oxygen plasma, a processing time of the oxygen plasma irradiation being from 1 to 600 seconds.

9. The method of manufacturing a functional substrate according to claim 1, the self-assembled film including a material that has a fluoro group.

10. The method of manufacturing a functional substrate according to claim 1, a plurality of constituent molecules of the self-assembled film being adsorbed on the substrate at a rate of from 0.01×10¹⁵ to 1×10¹⁵ pieces/cm² so as to form the self-assembled film.

11. A method of manufacturing a wiring substrate, comprising:
forming a functional substrate using the method of manufacturing a functional substrate according to claim 1; and
forming a film by applying the liquid material to the functional substrate.

12. A method of manufacturing an electro-optical device, using the method of manufacturing a wiring substrate according to claim 11.

13. A method of manufacturing an electronic apparatus, using the method of manufacturing a wiring substrate according to claim 11.
